(19) United States
(12) Patent Application Publication
(10) Pub. No.: US 2017/0255968 A1
(43) Pub. Date: Sep. 7, 2017

(54) ADVERTISING METHOD FOR SECURING AND EXPANDING CUSTOMERS BY USING CONTENTS

(71) Applicants: Chang Yoon OH, Seoul (KR); KAISOFT CO., LTD., Seoul (KR)

(72) Inventor: Kung-Mo KIM, Seoul (KR)

(73) Assignees: KAISOFT CO., LTD., Seoul (KR); Chang Yoon Oh, Seoul (KR)

(21) Appl. No.: 15/506,256

(22) PCT Filed: Aug. 27, 2015
(86) PCT No.: PCT/KR2015/008963

§ 371 Date: Feb. 24, 2017

(30) Foreign Application Priority Data
Sep. 1, 2014 (KR) 10-2014-0115714

(51) Int. Cl. G06Q 30/02

(52) U.S. Cl. CPC G06Q 30/0267

(57) ABSTRACT

An advertising method for securing and expanding customers by using contents, and a technical object thereof is to provide an advertising method of using a basic sponsor, in which a first sponsor matched with identification information received upon a request for a service application is to be registered as a basic sponsor of a first category of business to which the first sponsor belongs, for a user terminal from which the service application is requested.

### TECHNICAL FIELD

The present invention relates to an advertising method of using contents, and particularly, to an advertising method capable of securing and keeping customers whom sponsors know with higher royalty and also securing and keeping customers whom the other sponsors of similar categories of business know, by using an application of a user terminal such as a smart phone.

### RELATED ART

As a network technology such as Internet and a communication terminal such as a personal computer (PC), a notebook, a tablet PC and the like have been developed, a variety of advertisements have been made not only on an offline but also on an online.

In particular, as smart phones have been actively used, an advertisement through an application of the smart phone has been also widely utilized. In the advertisement using the application, an advertisement window is displayed on a screen configuring the application.

However, according to the advertisement using the application in the related art, the advertisement is provided, regardless of a function of the application, which instead causes an inconvenience to a user who uses the application.

Also, according to the advertising method using the application in the related art, the advertisements that are provided by the respective sponsors are simply exposed to the users. That is, it is not possible to continuously provide the user with only an advertisement of a specific sponsor.

Therefore, the sponsor cannot continue to provide customers of the sponsor with the advertisement, the user cannot continue to monitor the advertisement of the sponsor that the user wants, and the sponsor cannot attract and expand customers of the other sponsors, who are helpful to a business of the sponsor, as the customers of the sponsor.

### SUMMARY OF THE INVENTION

### Technical Problems

The present invention has been made in view of the above situations, and an object of the present invention is to provide an advertising method for securing and expanding customers by using contents, in which a first sponsor matched with identification information received upon a request for a service application is to be registered as a basic sponsor of a first category of business to which the first sponsor belongs, for a user who uses a user terminal from which the service application is requested.

### Solving Means

In order to achieve the above object, according to the present invention, there is provided an advertising method for securing and expanding customers by using contents. The method includes a step of a service application server managing a service application configured to provide advertisements including contents associated with a variety of categories of business; a step of the service application server registering sponsors in the service application server, and receiving, storing and managing advertisements, which are to be provided through the service application, from the sponsors; a step of transmitting the service application to a user terminal from which the service application is requested; a step of the service application server designating a first sponsor matched with identification information received upon the request for the service application as a basic sponsor (BS) of a first category of business to which the first sponsor belongs, for a user who uses the user terminal; a step of, regarding the other categories of business except for the first category of business, designating a specific sponsor as a partner sponsor (PS) for each of the categories of business; a step of, when a third sponsor requests to be registered as a basic sponsor for a second category of business for which a second sponsor has been designated as the partner sponsor (PS), registering the third sponsor as a basic sponsor (BS) of the second category of business for the user; a step of, when a request for advertisement for a category of business for which a basic sponsor has been registered is received from the user terminal, transmitting only an advertisement of the basic sponsor of the corresponding category of business to the user terminal; and a step of, when a request for advertisement for a category of business for which a basic sponsor has not been registered is received from the user terminal, transmitting only an advertisement of a sponsor registered as a partner sponsor for the corresponding category of business to the user terminal.

### Effects of the Invention

According to the advertising method of the present invention, the user who uses the service application can conveniently receive a variety of advertisements for a variety of categories of business.

Also, according to the advertising method of the present invention, the sponsor registered as a sponsor in the service application can attract not only the user who is a customer of the sponsor but also customers who are not customers of the sponsor but are customers of the basic sponsors of the other categories of business helpful to the sponsor and provide the customers with a variety of advertisements on the offline or online, thereby obtaining the advertisement effects. In particular, according to the present invention, each sponsor can secure and expand high-royalty customers.

Also, according to the advertising method of the present invention, a manager who manages the service application server can create profits associated with the advertisement or the registration of the basic sponsor from the sponsors.

In particular, according to the present invention, each sponsor can directly attract a customer, become a basic sponsor (BS) for the customer in the category of business thereof, and expose the advertisement contents through the service application (in this case, the sponsor pays a monthly fee, for example, 100 Korean Won per customer to the manager of the service application server). Also, according to the present invention, each sponsor can buy customers attracted by the other sponsors who engage in the same category of business or the other categories of business (in this case, the sponsor pays a monthly fee, for example, 200 Korean Won per customer to the manager of the service application server), become a basic sponsor (BS) for the customers in the category of business thereof, and expose the advertisement contents through the service application. Therefore, according to the present invention, as the advertisement contents increase in the service application, an advertisement chance of each sponsor can expand infinitely.

Also, when the sponsor buys the customer who was attracted by the sponsor or the other sponsor and thus becomes a basic sponsor (BS) for the customer in the category of business thereof, the customer is bound to the sponsor with respect to the advertisement for the category of business and remains as a high-royalty customer. For example, when a labor corporation A secedes from the service application server without paying the fee, the customers bound to the labor corporation A are unbound and exposed to the partner sponsor (PS). In this case, when a labor corporation B belonging to a labor consultation field buys the customers, the labor corporation A has the existing customers thereof taken away. Due to the concerns, each sponsor tries to continuously hold the customers secured by the sponsor. Therefore, each sponsor pays well the fee to the manager of the service application server, so that the manager of the service application server can increase the profits.

### BRIEF DESCRIPTION OF DRAWINGS

FIG. 1 depicts a configuration of an example of a communication system to which an advertising method for securing and expanding customers by using contents in accordance with the present invention is to be applied.

FIG. 2 depicts a configuration of an example of a service application server to which the advertising method for securing and expanding customers by using contents in accordance with the present invention is to be applied.

FIG. 3 is a flowchart of an example of the advertising method for securing and expanding customers by using contents in accordance with the present invention.

FIG. 4 exemplifies a state where a variety of applications including a service application are output on a display of a user terminal to which the advertising method for securing and expanding customers by using contents in accordance with the present invention is to be applied.

FIG. 5 is a flowchart of an example of depicting steps of executing a service application in the advertising method for securing and expanding customers by using contents in accordance with a first illustrative embodiment of the present invention.

FIG. 6 is a flowchart of an example of depicting steps of executing the service application in the advertising method for securing and expanding customers by using contents in accordance with a second illustrative embodiment of the present invention.

### DETAILED DESCRIPTION OF ILLUSTRATIVE EMBODIMENTS

Hereinafter, illustrative embodiments of the present invention will be described in detail with reference to the accompanying drawings.

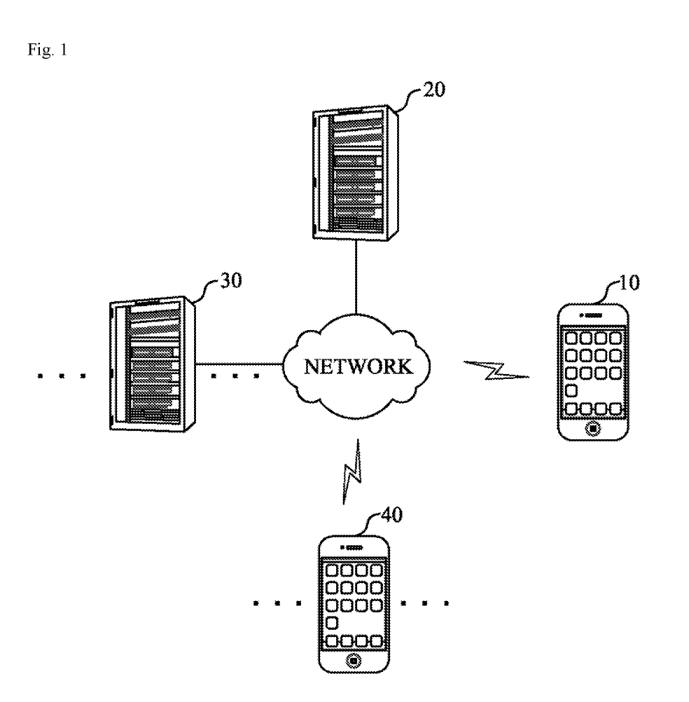

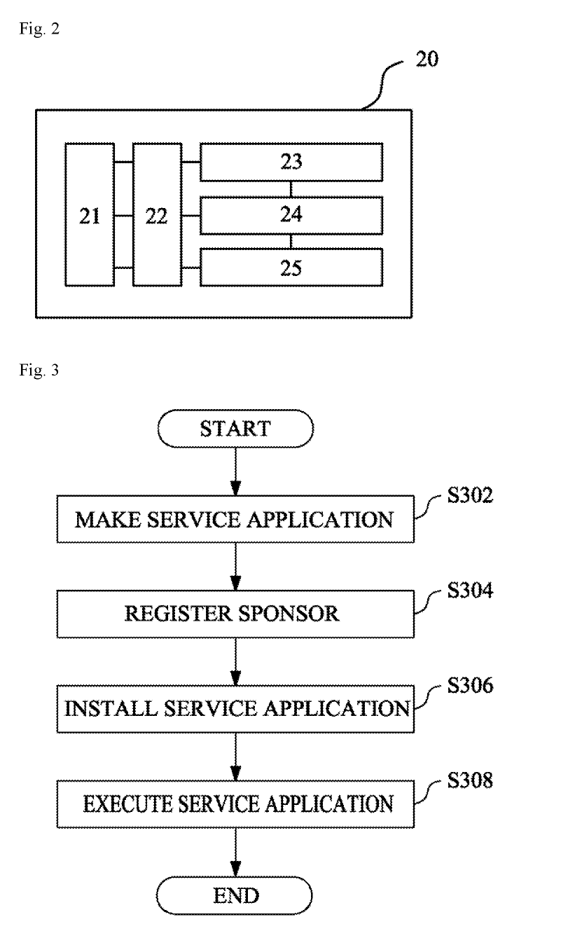

FIG. 1 depicts a configuration of an example of a communication system to which an advertising method for securing and expanding customers by using contents in accordance with the present invention is to be applied, and FIG. 2 depicts a configuration of an example of a service application server to which the advertising method for securing and expanding customers by using contents in accordance with the present invention is to be applied.

As shown in FIG. 1, a communication system to which an advertising method for securing and expanding customers by using contents (hereinafter, simply referred to as ‘advertising method’) in accordance with the present invention is to be applied includes a service application server 20 configured to manage a service application, sponsor servers 30 of sponsors who want to make advertisements through the service application, and a user terminal 10 of a user who wants to use the service application, and companion terminals 40 of companions who are recommended for the service application by the user.

First, the service application server 20 is configured to make and distribute the service application. When a sponsor of the service application is registered, the service application server 20 can add an advertisement, which can be used by the sponsor, to the service application.

The service application server 20 may be a general server that has been currently used and can be configured as shown in FIG. 2 so as to perform the above-described functions.

That is, the service application server 20 may include a communication unit 21 configured to perform communication with the user terminal 10, the companion terminals 40 and the sponsor servers 30, an input unit 23 configured to receive a variety of information from a manager of the service application server 20, an output unit 24 configured to output a variety of information necessary to manage the service application server 20, a storage unit 25 configured to store and manage advertisements including contents associated with a variety of categories of business transmitted from the sponsor servers 30 and information about the service application, and a control unit 22 configured to control functions of the respective configurations.

[symbol]

The user terminal 10 is a terminal configured to perform communication with the service application server 20 through a network. In particular, a smart phone capable of executing the service application can be exemplified.

The smart phone indicates an intelligent terminal in which computer-support functions such as Internet communication and information search are added to a portable phone, and a variety of applications that a user wants can be installed therein.

However, the user terminal 10 is not limited to the smart phone. That is, a variety of terminals capable of providing the service application, like the smart phone, can be used as the user terminal 10.

[symbol]

The companion terminal 40 is a terminal 40 that is to be used by a companion who has been recommended for the service application by the user who uses the user terminal 10, and can perform the same functions as the user terminal 10.

[symbol]

The sponsor server 30 is a server of a sponsor who intends to provide the service application with an advertisement and can be configured by a general server that has been currently used.

However, the sponsor server 30 may be a terminal that is the same type as the user terminal 10. That is, a sponsor who wants to make an advertisement through the service application can transmit the advertisement to the service application by using a server or can transmit the advertisement to the service application by using a terminal such as the smart phone.

[symbol]

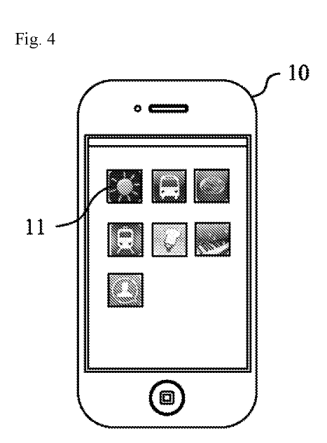

FIG. 3 is a flowchart of an example of an advertising method for securing and expanding customers by using contents in accordance with the present invention, and FIG. 4 exemplifies a state where a variety of applications including a service application are output on a display of a user terminal to which the advertising method for securing and expanding customers by using contents in accordance with the present invention is to be applied.

As shown in FIG. 3, the advertising method for securing and expanding customers by using contents in accordance with the present invention includes a step (S302) of a service application server 20 managing a service application configured to provide advertisements including contents associated with at least two or more categories of business, a step (S304) of by the service application server 20 registering sponsors in the service application server 20, and receiving and managing advertisements to be provided through the service application and identification information from the sponsors, a step (S306) of transmitting the service application to a user terminal 10 from which the service application is requested, and a step (S308) of the service application server 20 designating a first sponsor matched with identification information received upon a user's request for a membership of the service application, as a basic sponsor of a first category of business to which the first sponsor belongs, for the user terminal 10, when the service application is executed in the user terminal 10, transmitting an advertisement, which is to be provided by the first sponsor, to the user terminal 10 and transmitting information about the other categories of business to the user terminal 10, and when any one of the other categories of business is selected, transmitting an advertisement, which is provided by at least one of sponsors belonging to the selected category of business, to the user terminal 10.

In the below, the advertising method for securing and expanding customers by using contents in accordance with the present invention is described while the smart phones are exemplified as the user terminal 10 and the companion terminal 40. However, as described above, since the user terminal 10 and the companion terminal 40 are not limited to the smart phones, the advertising method for securing and expanding customers by using contents in accordance with the present invention can be applied to a variety of terminals configured to perform similar functions to the smart phone.

[symbol]

<1. Service Application Making and Sponsor Registration (S302)>

A producer of the service application makes a service application capable of providing advertisements including contents associated with at least two or more categories of business, and manages the service application through the service application server (S302).

The categories of business can be diversely classified.

For example, the categories of business can be classified into an eviction suit, a medical suit, a sexual violence suit, an administrative litigation, a land compensation suit, an industrial disaster suit, a dismissal suit, a criminal suit, a damage suit and the like.

The categories of business can be classified into a litigation business, a patent business, a medical business, a tour business, a restaurant and the like, as a high classification level category, by a primary classification. Each of the businesses can be classified into sub-categories of business of a subclass category by a secondary classification. For example, the litigation business classified by the primary classification can be classified into an eviction suit, a medical suit, a sexual violence suit, an administrative litigation, a land compensation suit, an industrial disaster suit, a dismissal suit, a criminal suit, a damage suit and the like by the secondary classification, and the restaurant can be classified into a Western restaurant, a Chinese restaurant, a Japanese restaurant and the like.

As described above, the categories of business can be classified on the basis of diverse subjects and can be sub-divided by a plurality of classifying procedures.

[symbol]

<2. Sponsor Registration (S304)>

The service application server 20 registers sponsors in the service application server 20, and receives and manages advertisements including contents associated with the categories of business to be provided through the service application from the sponsors (S304). If the category of business is classified into subclass categories, one sponsor can register a variety of advertisements for the subclass categories in the category of business of high classification level when registering the advertisements.

Each of the sponsors registered as sponsors in the service application server 20 scan register user terminal numbers of customers of the sponsor in the service application server 20. In this case, the service application server 20 can transmit a guidance message for promoting the service application to user terminals of the customers registered by the sponsor. However, the guidance message may also be directly transmitted to the user terminals by the sponsor.

[symbol]

<3. Service Application Download (S306)>

The service application is transmitted to the user terminal 10 from which the service application is requested (S306).

For example, a user who received the guidance message can download the service application through the user terminal 10 and install the same in the user terminal 10. In this case, the user can transmit identification information to the service application server 20 upon installation of the service application or upon subscription of the service application. The identification information may be a phone number of the user terminal.

Also, the sponsor can promote the service application through a variety of wired or wireless web pages (home page, blog and the like) and SNS (kakao talk, facebook, twitter and the like), which are directly managed by the sponsor or are made to promote the sponsor, and can provide identification information of the sponsor associated with the service application, for example, a phone number of the sponsor, a name of the sponsor or a variety of identification codes. In this case, the user can subscribe to the service application server 20 on the basis of the identification information, and download and install the service application in the user terminal 10. The identification information may be the phone number of the sponsor or the name of the sponsor, which the user knows. Also, the identification information may be an identification code such as a nickname or abbreviation of the sponsor, an advertisement phrase and the like.

As described above, the identification information may be the phone number of the user terminal, the phone number of the sponsor that the user knows, the name of the sponsor that the user knows, or the identification code matched with the sponsor that the user knows.

The user terminal 10 may be a smart phone. The smart phone indicates an intelligent terminal in which computer-support functions such as Internet communication and information search are added to a portable phone, and a variety of applications that a user wants can be installed therein.

The user can visit a variety of websites through the smart phone and search a variety of information. Also, the user can download an application to be applied to the advertising method for securing and expanding customers by using contents in accordance with the present invention (hereinafter, simply referred to as ‘service application’) from an app store and enable the service application to execute the above-described functions.

Herein, the app store indicates a store from which the service application can be downloaded. The app store performs functions of storing a variety of applications (Apps) including the service application and transmitting the service application to the smart phone 10 when a download request is received from the smart phone 10.

That is, the app store is an abbreviation of ‘Application Store’ and indicates a ‘mobile content (software) market’ on the online where mobile applications (content applications to be mounted in a mobile phone, such as a schedule, an address list, an alarm, a calculator, a game, a moving picture, an Internet connection, a music reproduction, a navigation, a word processor, an excel and the like) can be freely bought and sold.

The app store transmits to the user terminal 10 the service application transmitted from the service application server 20. Therefore, substantially, the service application is transmitted from the service application server 20 to the user terminal 10. FIG. 4 depicts a state where the service application 11 is installed in the smart phone 10.

[symbol]

<4. Service Application Execution (S308)>

When the service application is transmitted to the user terminal 10 from which the service application is requested (S306), the service application server 20 registers a first sponsor matched with the identification information received upon the request for the service application as a basic sponsor (BS) of a first category of business to which the first sponsor belongs for the user terminal 10, when the service application is executed in the user terminal 10, the service application server transmits an advertisement, which is provided by the first sponsor, to the user terminal 10 and transmits the information about the other categories of business to the user terminal 10, and when one of the other categories of business is selected, the service application server transmits an advertisement, which is provided by at least one of sponsors belonging to in the selected category of business, to the user terminal 10 (S308).

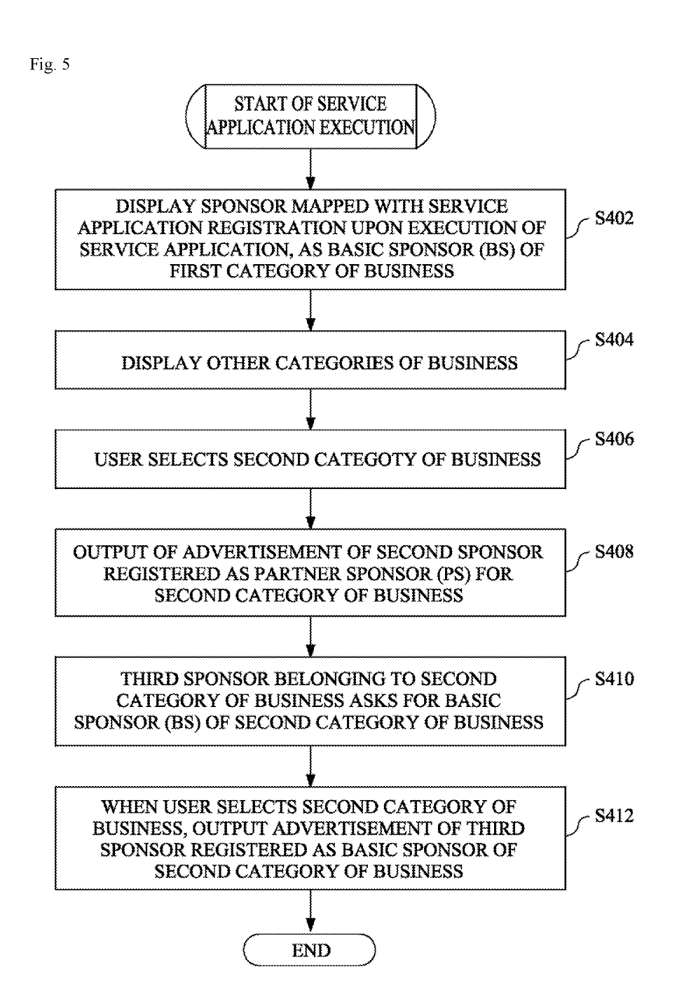

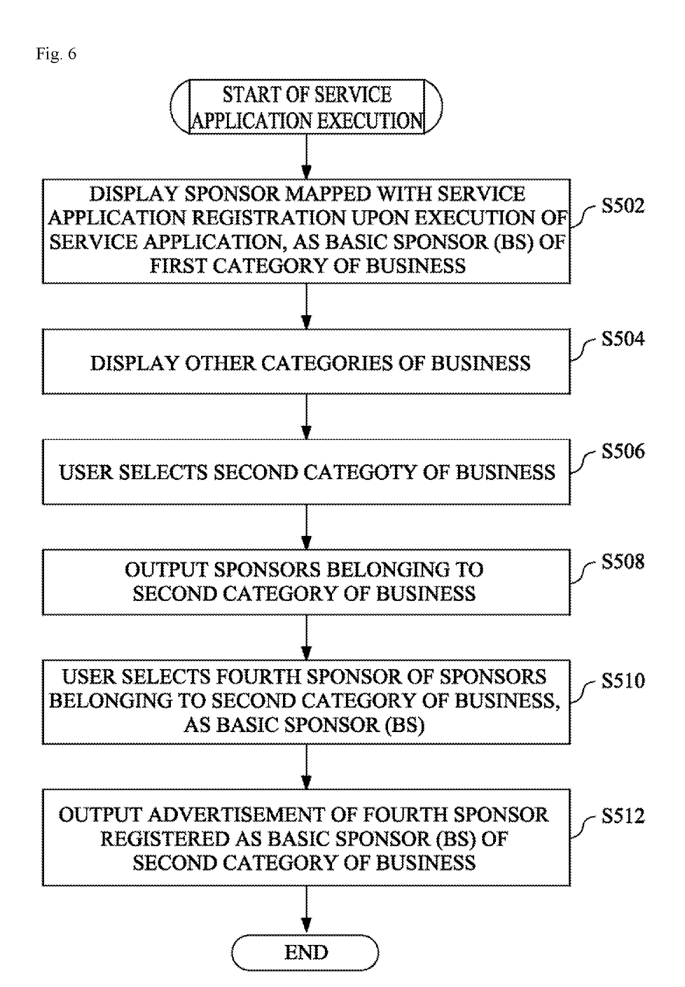

The service application execution step (S308) can be classified into a first illustrative embodiment and a second illustrative embodiment. The first illustrative embodiment is described with reference to FIG. 5, and the second illustrative embodiment is described with reference to FIG. 6.

[symbol]

FIG. 5 is a flowchart of an example of depicting steps of executing the service application in the advertising method for securing and expanding customers by using contents in accordance with a first illustrative embodiment of the present invention.

In the advertising method for securing and expanding customers by using contents in accordance with the present invention, the step (S308) of transmitting the advertisement to the user terminal includes a step (S402) of the service application server 20 managing a service application configured to provide advertisements including contents associated with a variety of categories of business, registering sponsors in the service application server, receiving, storing and managing advertisements, which are to be provided through the service application, from the sponsors, transmitting the service application to the user terminal 10 from which the service application is requested, and designating a first sponsor matched with the identification information received upon a request for the service application, as a basic sponsor (BS) of a first category of business to which the first sponsor belongs, for the user who uses the user terminal, steps (S404, S406, S408) of regarding the other categories of business except for the first category of business, designating a specific sponsor as a partner sponsor (PS) for each of the categories of business, and steps of, when a third sponsor requests to be registered as a basic sponsor for a second category of business for which a second sponsor has been designated as the partner sponsor (PS) (S410), registering the third sponsor as a basic sponsor (BS) of the second category of business for the user (S412), when a request for advertisement for a category of business for which a basic sponsor has been registered is received from the user terminal, transmitting only an advertisement of the basic sponsor of the category of business to the user terminal, and when a request for advertisement for a category of business for which a basic sponsor has not been registered is received from the user terminal, transmitting only an advertisement of a sponsor registered as a partner sponsor for the corresponding category of business to the user terminal (S412).

[symbol]

<1. Output of Advertisement of Basic Sponsor (S402)>

First, the service application server 20 registers the first sponsor matched with the information received upon the request for the service application, as the basic sponsor (BS) of the first category of business to which the first sponsor belongs.

For example, in the step (S306) of installing the service application, when the user requests the service application by using the guidance message and then inputs the phone number of the user terminal into the service application server 20, the first sponsor having requested the guidance message is registered as the basic sponsor (BS) for the user terminal or the user (hereinafter, simply referred to as ‘for the user’) in the first category of business. Since the first sponsor has registered the phone number of the user terminal 10 of the user in the service application server, the guidance message is transmitted to the user terminal 10. Therefore, when the user inputs the user terminal number, the service application server 20 can recognize that the guidance message has been transmitted by the first sponsor. For example, the first sponsor can register the phone number of the user, which was directly acquired from the user or was acquired through a name card collection using a variety of events, in the service application server and then transmit the guidance message for promoting the service application to the user by using the phone number. Upon the installation of the service application, the user can transmit the phone number to the service application server 20. The phone number of the user terminal is input as the identification information. In this case, the service application server 10 is registered as the basic sponsor (BS) of the first category of business for the user.

As another example, in the step (S306) of installing the service application, when the user is registered in the service application server 20, the user can input the phone number of the first sponsor (for example, a phone number of a restaurant, a beauty shop, a lawyer office or the like), which was acquired through the web page, a name of the first sponsor or an identification code matched with the first sponsor. The phone number, the name or the identification code input by the user is input as the identification information. In this case, when the first sponsor matched with the phone number, the name or the identification code input by the user has been already registered in the service application server 20, the service application server 20 registers the first sponsor, as the basic sponsor (BS) for the user, in the first category of business.

In this case, when the user executes the service application through the user terminal 10, an advertisement that is provided by the first sponsor is basically provided through the service application.

First, when the service application is executed, the advertisement that is provided by the first sponsor can be immediately provided together with the name of the first sponsor. In this case, the service application server 10 can provide menus by which it is possible to select advertisements, which are provided by other sponsors belonging to the first category of business, through the service application, and also provide menus by which it is possible to select advertisements, which are provided by sponsors belonging to the other categories of business, through the service application.

Second, when the service application is executed, the service application server 20 can provide menus by which it is possible to select one of the diverse categories of business. When the user selects the first category of business from the menus, the service application server can provide the name of the first sponsor and the advertisement, which is provided by the first sponsor, through the service application.

Making an additional remark, the first sponsor is registered as the basic sponsor of the first category of business only for the user.

Therefore, when a sponsor s, which is matched with the identification information input when another user downloads the service application and registers the same in the service application server 20, belongs to a second category of business, the sponsor s is registered as the basic sponsor of the second category of business, for another user.

Also, the user can see an advertisement, which is provided by a sponsor m, through the menus by which it is possible to select advertisements provided by other sponsors belonging to the first category of business. In this case, the user can select the sponsor m, as the basic sponsor of the first category of business. In this case, when the user selects the first category of business, the service application server 20 can transmit a name of the sponsor m and the advertisement, which is provided by the sponsor m, to the user terminal 10 through the service application.

Herein, the advertisement may include a variety of contents. For example, the contents may be calculation contents for providing a calculation-related service or information contents for providing a variety of information, irrespective of calculation.

The calculation contents are contents provided in a calculator form so as to provide information requiring a calculation, and the information contents may be contents that a sponsor provides a professional knowledge relating to a business of the sponsor.

For example, when the sponsor of the calculation contents is an accountant, a labor attorney, a lawyer, a patent attorney or the like, the calculation contents may provide contents by which an annual paid holiday, extra benefits for advance notice of dismissal, parental leave benefits, a minimum wage, unemployment benefits, bereaved benefits, patent application fee and the like can be directly calculated.

When a sponsor of the information contents is a mutual aid company, the information contents may provide information relating to funeral rites or preparation and ancestral rites. In this case, a manager of the mutual aid company can provide a variety of information about the mutual aid company through the service application, together with the information contents. Also, when the sponsor of the information contents is a patent office, the information contents may be a variety of information relating to a patent application. In this case, a manager of the patent office can provide a variety of information about the patent office through the service application, together with the information contents.

In the contents, basically, at least one of the phone number, the name and the identification code of the sponsor may be displayed.

[symbol]

<2. Output of Other Categories of Business (S404)>

As described above, when the service application is executed, the service application server 20 can output the advertisement, which is provided by the first sponsor, through a main screen, together with the name and the like of the first sponsor (basic sponsor) matched with the information received upon the request for the service application.

In this case, as described above, the service application server 20 may provide the menus by which it is possible to select the advertisements, which are provided by the other sponsors belonging to the first category of business, through the service application, and can also provide the menus by which it is possible to select the advertisements, which are provided by the sponsors belonging to the other categories of business, through the service application (S404).

Also, when the service application is executed, the service application server 10 can preferentially provide menus by which it is possible to select any one of the diverse categories of business (S404).

Making an additional remark, the service application server designates the first sponsor matched with the identification information received upon the request for the service application, as the basic sponsor (BS) of the first category of business to which the first sponsor belongs, for the user who uses the user terminal. After that, when a request for advertisement for the category of business for which the basic sponsor has been registered is received from the user terminal, the service application server can transmit an advertisement of the basic sponsor of the corresponding category of business to the user terminal. In this case, only the advertisement of the basic sponsor may be provided, or menus by which it is possible to search the advertisements of the other sponsors belonging to the first category of business and the other categories of business may be provided together with the advertisement of the basic sponsor.

[symbol]

<3. Output of Advertisement of Partner Sponsor of Second Category of Business (S406, 408)>

When the second category of business is selected from the other categories of business (S406), the service application server 20 transmits an advertisement of a second sponsor registered as a partner sponsor (PS) of the sponsors belonging to the second category of business to the user terminal 10 (S408).

For example, although the first sponsor has been registered as the basic sponsor for the user with respect to the first category of business, the basic sponsor has not been registered yet for the remaining categories of business.

The service application server 20 can set the partner sponsor for each of the categories of business through a variety of methods.

For example, the service application server 20 can set a second sponsor who pays a constant fee in a unit of one month or one year, as a partner sponsor of the second category of business to which the second sponsor belongs. In this case, when the user for whom the first sponsor is matched as the basic sponsor of the first category of business selects the second category of business, the service application server 20 can transmit a name of the second sponsor and an advertisement, which is provided by the second sponsor, through the service application.

In the above example, the service application server 20 can provide menus by which it is possible to provide advertisements of the other sponsors belonging to the second category of business, through the service application.

The user can set, as the basic sponsor, a sponsor n of the other sponsors belonging to the second category of business. In this case, when the user selects the second category of business, the service application server 20 can provide a name of the sponsor n selected as the basic sponsor by the user and an advertisement, which is provided by the sponsor n, instead of the second sponsor.

Making an additional remark, the partner sponsor (PS) is set by the service application server 20, and is commonly applied to all the users or all the user terminals. However, the basic sponsor (BS) is set by each user or each sponsor and can be differently set for each category of business and each user. Therefore, when the users who have not set the basic sponsor for the second category of business select the second category of business through the user terminals, the service application server 20 transmits the name of the second sponsor and the advertisement, which is provided by the second sponsor, to all the user terminals. However, when a user p having selected a basic sponsor for the second category of business selects the second category of business, the service application server 20 transmits a name of a sponsor selected as the basic sponsor and an advertisement, which is provided by the sponsor, to the user terminal that is used by the user p.

As described above, according to the advertising method of the present invention, when an advertisement request for a category of business for which the basic sponsor has not been registered is received from the user terminal 10, the service application server can transmit an advertisement of a sponsor registered as the partner sponsor for the corresponding category of business to the user terminal. In this case, only the advertisement of the partner sponsor may be provided, or menus by which it is possible to search the advertisements of the other sponsors belonging to the category of business to which the partner sponsor belongs can be transmitted together with the advertisement of the partner sponsor.

[symbol]

<4. Registration of Basic Sponsor of Second Category of Business (S410)>

In a case that the second sponsor has been registered as the partner sponsor (PS) for the second category of business, when a third sponsor belonging to the second category of business asks for a basic sponsor (BS) of the second category of business, the service application server 20 can register the third sponsor as a basic sponsor (BS) of the second category of business (S410).

For example, the third sponsor can be a basic sponsor (BS) of the second category of business for the user, on condition that the third sponsor pays a predetermined fee to the manager of the service application server 20.

In this case, when the third sponsor requests to be registered as a basic sponsor of the second category of business for which the second sponsor has been designated as the partner sponsor (PS), the service application server 20 can provide the third sponsor with at least one of a region, a sex and an age of the user, the advertisement for which the user has searched, and the category of business for which the basic sponsor (BS) has been registered for the user. When the third sponsor retrieves the information and then finally requests to be a basic sponsor for the user, the service application server 20 can register the third sponsor as a basic sponsor of the user for the second category of business.

[symbol]

<5. Output of Advertisement of Basic Sponsor of Second Category of Business (S412)>

In a case that the third sponsor has been registered as a basic sponsor (BS) of the second category of business for the user, when the second category of business is selected by the user terminal 10, the service application server 20 can transmit a name of the third sponsor and an advertisement, which is provided by the third sponsor, to the user terminal 10 (S412).

However, even when the third sponsor has been registered as a basic sponsor (BS) of the second category of business, the user can register a sponsor k of the other sponsors belonging to the second category of business, as a basic sponsor of the second category of business. In this case, when the user selects the second category of business, a name of the sponsor k and an advertisement, which is provided by the sponsor k, are provided through the service application.

[symbol]

<6. Disqualification of Basic Sponsor of Second Category of Business>

In a case that the third sponsor registered as the basic sponsor of the second category of business for the user does not pay the fee for a preset time period, when the second category of business is selected by the user terminal 10, the service application server 20 can transmit the advertisement of the second sponsor registered as the partner sponsor (PS) to the user terminal 10. This is described in detail, as follows.

For example, the sponsors using the present invention as described above can pay 100 Korean Won per customer to the manager of the service application server 20, as a fee for the advertisement exposure, which is an advertisement fee to the customers who were encouraged to download the service application by the sponsors through SNS and the like.

In this case, when the labor corporation A encourages 50 customers to download the service application, the 50 customers are provided with contents (advertisement) of the labor corporation A with respect to a labor consultation of the diverse categories of business. That is, for the 50 customers, the labor corporation A is registered as a basic sponsor (BS) of the labor consultation (the category of business).

The service application server 20 can provide the 50 customers with the advertisements of the basically set sponsors (the partner sponsors (PS)) with respect to the remaining categories of business.

In this case, for each of the remaining categories of business for which the partner sponsors (PS) have been registered, another sponsor can buy a right to provide an advertisement for the 50 customers by paying a fee. For example, when a lawyer office K belonging to a category of bankruptcy consultation business and providing a bankruptcy-related advertisement pays a prescribed fee to the manager of the service application server 20 so as to attract the 50 customers as customers of the lawyer office K (in this case, since the 50 customers are not customers of the lawyer office K, a fee for the advertisement exposure, i.e., 200 Korean Won per customer is paid to the manager), the lawyer office K is registered as a basic sponsor of the category of bankruptcy consultation business for the 50 customers. Therefore, when the 50 customers execute the service application and select the bankruptcy consultation, a name of the lawyer office K and an advertisement (contents), which is provided by the lawyer office K, not the sponsor set as the partner sponsor with respect to the bankruptcy consultation, are provided to the 50 customers through the service application.

Making an additional remark, the basic sponsor for the labor consultation of the 50 customers is the labor corporation A and the basic sponsor for the bankruptcy consultation of the 50 customers is the lawyer office K. Therefore, when the 50 customers select the labor consultation, the name of the labor corporation A and the advertisement, which is provided by the labor corporation A, are provided through the service application, when the 50 customers select the bankruptcy consultation, the name of the lawyer office K and the advertisement, which is provided by the lawyer office K, are provided through the service application, and when the 50 customers select the remaining categories of business, a name of a sponsor selected as a partner sponsor for each category of business and the advertisement, which is provided by the sponsor, are provided through the service application.

In this way, each sponsor can directly attract the customer and expose the advertisement of the sponsor through the service application (in this case, the sponsor pays a monthly fee of 100 Korean Won per customer, for example), or buy a customer attracted by the other sponsor (in this case, the sponsor pays a monthly fee of 200 Korean Won per customer) and become a basic sponsor (BS) for the customer.

In this way, as the advertisements to be exposed through the service application increase, each sponsor can have a chance of infinitely expanding an advertisement opportunity.

Also, when each sponsor becomes a basic sponsor (BS) for the customer attracted by the sponsor or the other sponsor, the customer is bound to the sponsor with respect to the category of business to which the sponsor belongs. Therefore, the customer remains as a high-royalty customer.

If the labor corporation A does not pay a fee to the manager of the service application server 20 or secedes from the service application server 20 and then the 50 customers select the labor consultation, the name of the partner sponsor (PS), which has been registered by the service application server 20 with respect to the labor consultation, and the advertisement, which is provided by the partner sponsor, are provided to the 50 customers through the service application.

Also, if the labor corporation A does not pay a fee to the manager of the service application server 20 or secedes from the service application server 20, a labor corporation B belonging to the category of labor consultation business can buy the 50 customers. In this case, the labor corporation A has the existing customers thereof taken away. Due to the concerns, the labor corporation A tries to continuously hold the customers secured by the labor corporation A. Therefore, each sponsor will pay well the fee to the manager of the service application server.

Also, a sponsor who intends to buy a customer of the other sponsor can search customers attracted by the other sponsor who may relate to a business of the sponsor. For example, a sponsor belonging to a category of labor business can search and buy a customer, for which a partner sponsor (PS) is set, of the categories of business included in the lawyer field. In this case, the service application server 20 can provide menus by which it is possible to search conditions of a region, a sex, an age and the like.

Making an additional remark, when the basic sponsor has been already registered for the user with respect to a specific category of business, the other sponsor cannot be a basic sponsor of the specific category of business for the user. However, the other sponsors can be a basic sponsor of a category of business for which a basic sponsor has not been registered for the user and only a partner sponsor has been registered.

However, the user can register another sponsor as a basic sponsor of a category of business for which a basic sponsor has been registered by a sponsor.

[symbol]

<7. Introduction of Service Application to Companion>

The service application server 20 can provide a companion recommendation menu through the service application.

When a user recommends the service application to a companion through the companion recommendation menu and the companion downloads the service application by using the companion terminal 40, the basic sponsor (BS) and the partner sponsor (PS) set by the user are also applied to the companion, as they are.

In this case, the basic sponsor (BS) or the partner sponsor (PS) may provide the user with a point. The user can use a variety of services, which are provided by the basic sponsor (BS) or the partner sponsor (PS), by using the point. In particular, since the user may be a premium customer for the basic sponsor (BS), the basic sponsor may provide the user with more points than the partner sponsor.

Therefore, when a sponsor whom the user may use in many cases is registered as the basic sponsor (BS) as many as possible, the user may receive more points by recommending the service application to the companion.

Making an additional remark, when the user recommends the service application to the companion through the companion recommendation menu and then the companion executes the service application with the companion terminal 40, the service application server 20 applies the basic sponsor or the partner sponsor matched with the user to the companion.

In this case, the basic sponsor or the partner sponsor matched with the user provides the user with the point. The user can use the contents, which are provided by the basic sponsor or the partner sponsor, by using the point.

[symbol]

<8. Cooperation between Sponsors>

In the above, each sponsor individually makes an advertisement. However, sponsors who can cooperate with each other can make an advertisement with a common identification code, in addition to the individual identification information.

For example, a labor corporation C, a lawyer office D, a patent office E and a Garden H can register one common identification code in the server and make an advertisement with the common identification code.

In this case, when the user downloads the service application by using the common identification code as the identification information, the labor corporation C, the lawyer office D, the patent office E and the Garden H can be basic sponsors (BS) for the user with respect to a category of labor consultation business, a category of legal consultation business, a category of patent consultation business and a category of restaurant business.

Making an additional remark, when the common identification code matched with the plurality of sponsors is received as the identification information, the service application server 20 can register the sponsors matched with the common identification code as basic sponsors for the user with respect to the categories of business to which the sponsors belong.

[symbol]

FIG. 6 is a flowchart of an example of depicting a step of executing the service application in the advertising method for securing and expanding customers by using contents in accordance with a second illustrative embodiment of the present invention. In the below, the same or similar configurations as or to the first illustrative embodiment will be omitted or simply described.

In the advertising method for securing and expanding customers by using contents in accordance with the present invention, the step (S308) of transmitting the advertisement to the user terminal includes, a step (S502) of the service application server 20 managing a service application configured to provide advertisements including contents associated with a variety of categories of business, registering sponsors in the service application server, receiving, storing and managing advertisements, which are to be provided through the service application, from the sponsors, transmitting the service application to a user terminal from which the service application is requested, and designating a first sponsor matched with identification information received upon the request for the service application, as a basic sponsor (BS) of a first category of business to which the first sponsor belongs for a user who uses the user terminal, a step (S504) of, when the service application is executed in the user terminal, the service application server transmitting an advertisement, which is provided by the first sponsor, to the user terminal, and transmitting information about the other categories of business to the user terminal, steps of, when an advertisement request for a second category of business of the other categories of business is received from the user terminal (S506), the service application server transmitting information about sponsors belonging to the second category of business to the user terminal (S508), and steps of, when any one of the information about the sponsors belonging to the second category of business is selected from the user terminal, the service application server registering the selected sponsor as a basic sponsor of the second category of business for the user (S510), when a request for advertisement for a category of business for which a basic sponsor has been registered is received from the user terminal, transmitting only an advertisement of the basic sponsor of the category of business to the user terminal (S512), and when a request for advertisement for a category of business for which which a basic sponsor has not been registered is received from the user terminal, the service application server transmitting information about sponsors belonging to the category of business for which a basic sponsor has not been registered to the user terminal and registering a basic sponsor for the category of business for which a basic sponsor has not been registered (S510).

[symbol]

<1. Output of Advertisement of Basic Sponsor (S502)>

Since the step (S502) of outputting the advertisement of the basic sponsor is the same as the first illustrative embodiment, the description thereof is omitted.

[symbol]

<2. Output of Other Categories of Business (S504)>

Since the step (S504) of outputting the other categories of business is the same as the first illustrative embodiment, the description thereof is omitted.

[symbol]

<3. Output of Sponsors of Second Category of Business (S506, 508) >

When a second category of business of the other categories of business is selected (S506), for example, the service application server 20 transmits the information about the sponsors belonging to the second category of business to the user terminal 10 (S508).

In the first illustrative embodiment, when the second category of business is selected, the name of the partner sponsor (PS) registered for the second category of business and the advertisement, which is provided by the partner sponsor, are provided through the service application.

However, in the second illustrative embodiment, the information about all the sponsors belonging to the second category of business, for example, the names and the like are provided through the service application.

[symbol]

<4. Registration of Basic Sponsor of Second Category of Business (S510)>

When a fourth sponsor of the sponsors belonging to the second category of business is selected as a basic sponsor (BS) of the second category of business by the user terminal 10, the service application server 20 registers the fourth sponsor as a basic sponsor (BS) of the second category of business.

In the first illustrative embodiment, basically, the sponsor asks for the registration of the basic sponsor (BS). However, in the second illustrative embodiment, the user asks for a sponsor who the user wants, as a basic sponsor (BS). However, also in the first illustrative embodiment, the user can ask for a sponsor who the user wants, as a basic sponsor (BS).

[symbol]

<5. Output of Advertisement of Basic Sponsor of Second Category of Business (S512)>

The step (S512) of outputting the advertisement of the basic sponsor of the second category of business is the same as the first illustrative embodiment.

For example, when the user selects the fourth sponsor as a basic sponsor of the second category of business and then selects the second category of business, the service application server 20 provides a name of the fourth sponsor and an advertisement, which is provided by the fourth sponsor, through the service application.

[symbol]

Making an additional remark, in the second illustrative embodiment of the present invention, when the user downloads the service application from the service application server 20 with an identifier of a specific sponsor, the specific sponsor becomes a basic sponsor (BS) for a category of business to which the specific sponsor belongs. When the user selects another category of business, the service application server 20 outputs information about all sponsors belonging to another category of business and the user can register one of the output sponsors as a basic sponsor (BS) of another category of business.

As described above, in the second illustrative embodiment of the present invention, when the advertisement request for the category of business for which the basic sponsor has been registered is received from the user terminal, the service application server transmits the advertisement of the basic sponsor of the category of business to the user terminal (S502, 512), when the advertisement request for the category of business for which the basic sponsor has not been registered is received from the user terminal (S506), the service application server transmits the information about the sponsors belonging to the category of business for which the basic sponsor has not been registered to the user terminal (S508), so that it is possible to register a basic sponsor for the category of business for which a basic sponsor has not been registered (S512).

The step of introducing the service application to the companion, which has been described in the first illustrative embodiment, can also be applied to the second illustrative embodiment.

Also, the cooperation step between the sponsors, which has been described in the first illustrative embodiment, can be applied to the second illustrative embodiment.

### INDUSTRIAL APPLICABILITY

One skilled in the art of the technical field of the present invention can understand that the present invention can be implemented in other specific forms without changing the technical spirit and essential features thereof. Therefore, it should be understood that the above-described illustrative embodiments are not limitative but just exemplary in all aspects. The scope of the present invention is defined in the claims, not the above descriptions, and all changes and modifications to be deduced from the claims and equivalents thereto are to be included in the scope of the present invention.

1. An advertising method for securing and expanding customers by using contents, the method comprising:
a step of a service application server managing a service application configured to provide advertisements comprising contents associated with a variety of categories of business;
a step of the service application server registering sponsors in the service application server, and receiving, storing and managing advertisements, which are to be provided through the service application, from the sponsors;
a step of transmitting the service application to a user terminal from which the service application is requested;
a step of the service application server designating a first sponsor matched with identification information received upon the request for the service application, as a basic sponsor (BS) of a first category of business to which the first sponsor belongs, for a user who uses the user terminal;
a step of, regarding the other categories of business except for the first category of business, designating a specific sponsor as a partner sponsor (PS) for each of the categories of business;
a step of, when a third sponsor requests to be registered as a basic sponsor for a second category of business for which a second sponsor has been designated as the partner sponsor (PS), registering the third sponsor as a basic sponsor (BS) of the second category of business for the user;
a step of, when a request for advertisement for a category of business for which a basic sponsor has been registered is received from the user terminal, transmitting only an advertisement of the basic sponsor of the corresponding category of business to the user terminal, and
a step of, when a request for advertisement for a category of business for which a basic sponsor has not been registered is received from the user terminal, transmitting only an advertisement of a sponsor registered as a partner sponsor for the corresponding category of business to the user terminal.

2. An advertising method for securing and expanding customers by using contents, the method comprising:
a step of a service application server managing a service application configured to provide advertisements comprising contents associated with a variety of categories of business;
a step of the service application server registering sponsors in the service application server, and receiving, storing and managing advertisements, which are to be provided through the service application, from the sponsors;
a step of transmitting the service application to a user terminal from which the service application is requested;
a step of the service application server designating a first sponsor matched with identification information received upon the request for the service application, as a basic sponsor (BS) of a first category of business to which the first sponsor belongs, for a user who uses the user terminal;
a step of, when the service application is executed in the user terminal, the service application server transmitting an advertisement, which is provided by the first sponsor, to the user terminal, and transmitting information about the other categories of business to the user terminal;
a step of, when a request for advertisement for a second category of business of the other categories of business is received from the user terminal, the service application server transmitting information about sponsors belonging to the second category of business to the user terminal;
a step of, when any one of the information about the sponsors belonging to the second category of business is selected from the user terminal, the service application server registering the selected sponsor as a basic sponsor of the second category of business for the user;
a step of, when a request for advertisement for a category of business for which a basic sponsor has been registered is received from the user terminal, transmitting only an advertisement of the basic sponsor of the category of business to the user terminal, and
a step of, when a request for advertisement for a category of business for which a basic sponsor has not been registered is received from the user terminal, the service application server transmitting information about sponsors belonging to the category of business for which a basic sponsor has not been registered to the user terminal and inducing the user to register a basic sponsor for the category of business for which a basic sponsor has not been registered.

3. The advertising method according to claim 1, wherein the identification information is a number of the user terminal, a phone number of a sponsor who the user knows, a name of a sponsor who the user knows, or an identification code matched with a sponsor who the user knows.

4. The advertising method according to claim 1, wherein the step of registering the third sponsor as a basic sponsor (BS) of the second category of business comprises:
a step of, when the third sponsor requests to be registered as a basic sponsor of the second category of business for which the second sponsor has been designated as the partner sponsor (PS), providing the third sponsor with at least one of a region, a sex and an age of the user, advertisements for which the user has searched, and the category of business for which the basic sponsor (BS) has been registered for the user, and
a step of, when the third sponsor finally requests to be a basic sponsor for the user, registering the third sponsor as a basic sponsor of the user for the second category of business.

5. The advertising method according to claim 1, further comprising a step of, when a common identification code matched with a plurality of sponsors is received as the identification information, the service application server registering the sponsors matched with the common identification code as basic sponsors of categories of business to which the sponsors belong, for the user.

6. The advertising method according to claim 1, further comprising:
a step of the service application server providing a companion recommendation menu through the service application;
a step of, when the user recommends the service application to a companion through the companion recommendation menu and the companion executes the service application in a companion terminal, applying the basic sponsor or partner sponsor matched with the user to the companion;
a step of the basic sponsor or partner sponsor matched with the user providing a point to the user, and
a step of the user using contents, which are provided by the basic sponsor or partner sponsor, by using the point.

7. The advertising method according to claim 2, wherein the identification information is a number of the user terminal, a phone number of a sponsor who the user knows, a name of a sponsor who the user knows, or an identification code matched with a sponsor who the user knows.

8. The advertising method according to claim 2, further comprising a step of, when a common identification code matched with a plurality of sponsors is received as the identification information, the service application server registering the sponsors matched with the common identification code as basic sponsors of categories of business to which the sponsors belong, for the user.

9. The advertising method according to claim 2, further comprising:
a step of the service application server providing a companion recommendation menu through the service application;
a step of, when the user recommends the service application to a companion through the companion recommendation menu and the companion executes the service application in a companion terminal, applying the basic sponsor or partner sponsor matched with the user to the companion;
a step of the basic sponsor or partner sponsor matched with the user providing a point to the user, and
a step of the user using contents, which are provided by the basic sponsor or partner sponsor, by using the point.
